(19) United States
(12) Patent Application Publication
(10) Pub. No.: US 2004/0119969 A1
(43) Pub. Date: Jun. 24, 2004

(54) Crack inspection system for inspecting parts

(76) Inventors: Andrej Schleicher, Belm (DE); Karl-Peter Brandt, Bramsche (DE); Gerhard Ey, Stenwede Drohne (DE)

Correspondence Address: MCGLEW & TUTTLE, PC, 1 SCARBOROUGH STATION PLAZA, SCARBOROUGH, NY, 10510-0827, US

(21) Appl. No.: 10/474,452

(22) PCT Filed: Jan. 9, 2003
(86) PCT No.: PCT/DE03/00043

(30) Foreign Application Priority Data
Jan. 10, 2002 (DE) 102 00 776.4

(51) Int. Cl. G01M 19/00; G01N 21/88; G01N 27/90

(52) U.S. Cl. 356/237.1; 73/865.9; 324/238

(57) ABSTRACT

Crack detection device with at least one detection unit (7) for checking parts (9, 10) for cracks with the use of a suitable crack detection method, wherein the detection unit (7) is movable by means of a moving unit (3) between at least two checking positions (8a, 8b), and one part of the parts to be checked (9, 10) can be fed to each of the checking positions (8a, 8b).

The present invention pertains to a crack detection device with at least one detection unit for checking parts for cracks using a suitable crack detection method, as well as to a method for checking the parts for cracks using the suitable crack detection method, wherein a first part of the parts to be checked is fed into a first checking position and checked for cracks with the use of the detection unit arranged in the first checking position.

Such crack detection devices or also crack detection units are usually used in manufacturing plants to check the finished products. Various types of crack detection units are distinguished. On the one hand, there are crack detection units that destroy the body to be checked during the checking, and, on the other hand, there are nondestructive crack detection units, to which the present invention pertains. Various crack detection methods, e.g., penetration methods, optical methods or eddy current methods are distinguished among the nondestructive crack detection units that are of interest here. The eddy current method is a suitable method for detecting cracks in bodies conducting electric current. Methods using X-rays are available as optical crack detection methods.

A crack detection unit according to the preamble is used in practice to detect cracks in parts with an outer contour that is rotationally symmetrical in the area of measurement. Such crack detection units are based on a base, which carries the complete checking means together with the test specimen feed and removal means. The test specimens are conveyed by means of a turntable into a transfer position. When the transfer position is reached, the test specimens are transferred by transfer devices into the checking device, where they are set into rotation for checking. After a predetermined speed of rotation has been reached, a sensor, which is coupled with a so-called setting master, which detects the contour of a corresponding sample specimen and transmits this contour scan with an offset suitable for the checking to the sensor (copying mechanism), scans the outer contour of the test specimens. After the completion of the checking, the sensor moves into a waiting position and remains there until after the test specimens have again been transferred back to the turntable and new test specimens have been transferred into the checking position and set into rotation.

A large number of parts are changed in the prior-art crack detection device when the crack detection unit is changed over from one type of test specimen to another, which leads to a great assembly effort and to long set-up times. Furthermore, the number of parts that can be checked per unit of time is rather small.

Based on this, the object of the present invention is to provide a device and a method in which the number of parts that can be checked per unit of time is increased.

This object is accomplished according to the present invention with a crack detection device according to claim 1 and with a method according to claim 20. Advantageous variants of the present invention are described in the dependent claims.

The crack detection device according to the present invention has at least one detection unit for checking parts for cracks using a suitable crack detection method, wherein the detection unit can be moved between at least two checking positions by means of a moving unit. One of the parts to be checked can be fed here to each of the checking positions.

In the method according to the present invention for checking the parts for cracks with the use of the suitable crack detection method, a first of the parts to be checked is fed to a first of the checking positions and checked for cracks with the use of the at least one detection unit located in the first checking position. Furthermore, a second of the parts to be checked is fed to a second of the checking positions, and the detection unit is moved to the second checking position after the checking of the first part. The second part is then checked for cracks with the use of the detection unit.

The present invention includes the technical teaching that the detection unit can be moved into at least two checking positions by means of a moving unit. This solution offers the advantage that more parts can be checked per unit of time, and the checking means has considerably shorter downtimes, which leads to higher efficiency.

Furthermore, the need for the setting master can be eliminated by the use of a programmable control (CNC) for controlling the detection unit, as a result of which faster change of the parts to be checked with other parts to be checked with a different shape and geometry is possible. Moreover, more different types of test specimens can be checked simultaneously on one machine corresponding to the number of checking positions.

Provisions are made in another measure improving the present invention to provide a feeding and removal unit, which comprises at least two linearly movable checking carriage units arranged vertically one on top of another and which moves the parts to be checked between different positions. A larger number of parts to be checked can thus be efficiently analyzed in a shorter time.

It is proposed according to a possible variant of the present invention that the linearly movable checking carriage unit be preferably moved between the three positions feeding position, checking position and removal position, because optimal utilization of all essential components of the crack detection device can thus be achieved and the downtimes are minimized.

It is proposed in another possible variant of the present invention that the parts to be checked be mounted rotatably in the checking position in the checking carriage unit, so that the checking carriage unit also assumes an abutment function besides a conveying function.

A control unit with a programmable contour tracing control is preferably provided, with which the movable detection unit can be controlled. As a result, reliable control, which can be performed with ease, is possible without many components, as, e.g., in the case of a copying mechanism. For simple operation, the contour tracing control may be programmed by means of scanning by guiding, e.g., the detection unit itself or a learning device (manually) along the checking section to be covered by the detection unit during the checking. However, the checking section to be covered may also be determined optically by means of image processing.

It is also advantageous for the detection unit to comprise at least one measuring sensor and for the detection unit comprising the measuring sensor to be arranged on a moving unit. Optimal utilization of the relatively expensive detection unit can thus be achieved while the downtimes are minimized.

The moving unit may preferably be a biaxial linear moving unit, because all the parts to be checked can thus be reached for checking in the checking positions, which are located essentially vertically one on top of another.

Moreover, provisions are made in another advantageous variant of the present invention for the parts to be checked to be moved by the feeding and removal unit via a checking carriage unit. Reliable conveying of the parts to be checked between the positions most important for the checking can thus be guaranteed.

Provisions are made in an advantageous variant of the present invention for the feeding and removal unit to have at least one longitudinal transfer system per checking position, which is coupled with the particular checking carriage unit. As a result, the transfer of the parts to be checked can be uncoupled in time from a cycle time, as a result of which downtimes can be very extensively avoided.

Moreover, it is advantageous that each longitudinal transfer system conveys different parts to be checked. Different parts can thus be fed in simultaneously during the checking.

Another significant advantage is that the detection unit of the checking means additionally has at least one distance measuring unit, which measures the distance between the detection unit and the part to be checked during the checking of a part to be checked among the parts. It can thus be guaranteed by means of a corresponding control circuit that the detection unit always has an optimal distance for the measurement from the part to be checked. Constant quality of the test results can thus be achieved, e.g., due to the uniform distance. Moreover, parts with an outer contour that is not rotationally symmetrical in the area of measurement can also be checked due to the permanent distance measurement, and the detection unit sets the desired distance from the parts to be checked by means of an automatic mechanism. At a further stage of development, the distance measurement may be used to obtain a self-learning system.

It is advantageous that the crack detection device has a carrying base, so that the crack detection device can be adjusted and set via this base.

In a favorable embodiment of the present invention, the drive unit sets the parts to be checked into rotary movement such that these have a speed of at least 1,000 revolutions [per minute?—Tr.Ed.], because optimal checking of the parts to be checked is thus guaranteed.

In another favorable embodiment of the present invention, the parts, especially ball pivots, are provided with an outer contour that is rotationally symmetrical in the area of measurement, so that contour tracing control can be embodied in an especially simple manner based on the geometric conditions.

To guarantee the shortest possible section between the feeding, checking and removal positions, it is advantageous for the checking position to be arranged between the feeding and removal positions, located on a common straight line with these.

Finally, it is advantageous for the crack detection method to be an eddy current method or an optical crack detection method, which can be embodied, e.g., by means of digital image processing.

The checking cycle according to the present invention may have, e.g., the following steps:

(a) Checking of a first of the parts fed into the first checking position for cracks by means of the detection unit arranged in the first checking position,

(b) feeding a next of the parts from the feeding position associated with the second checking position (second feeding position) to the second checking position,

(c) moving of the detection unit from the first checking position into the second checking position after the completion of the checking of the first part,

(d) checking of the next part for cracks by means of the detection unit arranged in the second checking position,

(e) conveying the first part from the first checking position into the removal position associated with that checking position (first removal position),

(f) feeding of a third of the parts from the first feeding position to the first checking position, and

(g) moving of the detection unit from the second checking position into the first checking position after the completion of the checking of the next [second—Tr.Ed.] part.

After process step (g), it is possible to return in the checking cycle to process step (a), in which the third part will then be checked as a first part.

The removal of the first part from the first checking position to the first removal position and the feeding of the third part from the first feeding position to the first checking position are preferably carried out during the checking of the next [second—Tr.Ed.] part.

The present invention will be described on the basis of a preferred embodiment with reference to the drawings. In the drawings,

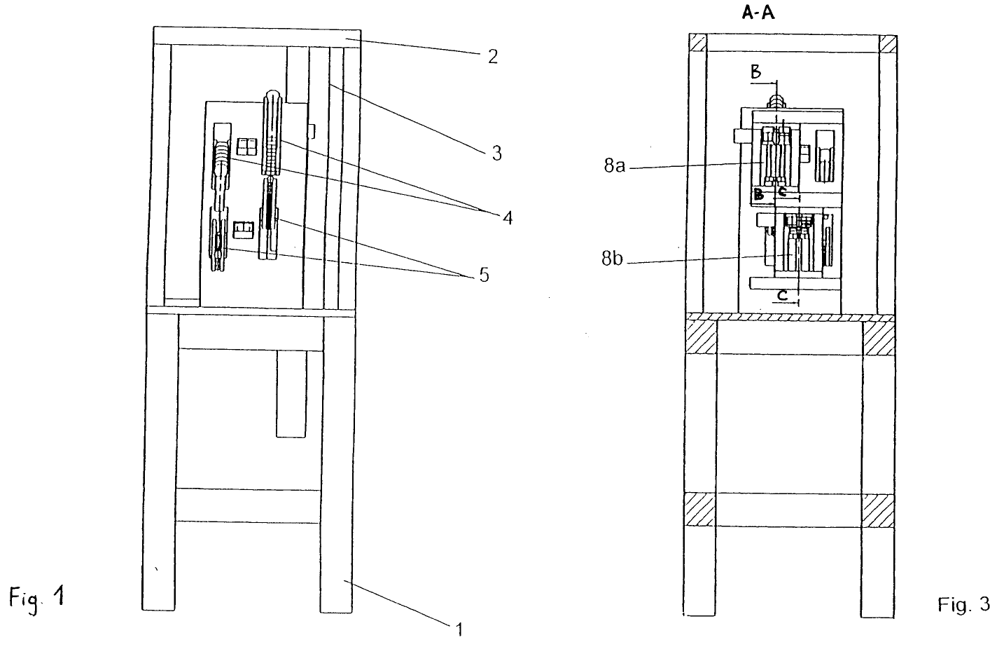

FIG. 1 shows the right-hand side view of an embodiment of the crack detection unit according to the present invention,

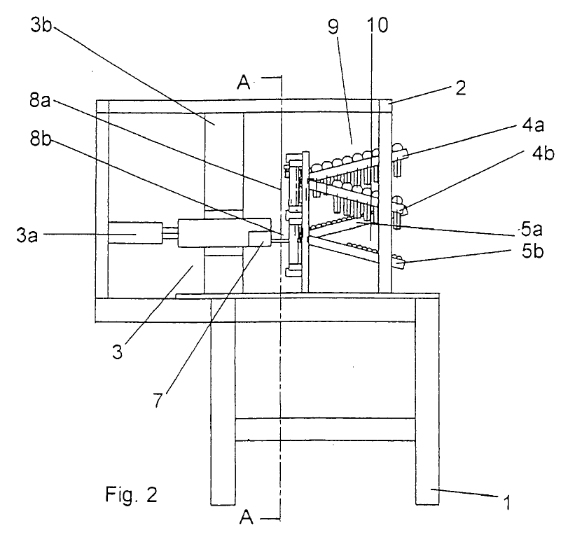

FIG. 2 shows the front view of the embodiment according to FIG. 1,

FIG. 3 shows section A-A according to FIG. 2,

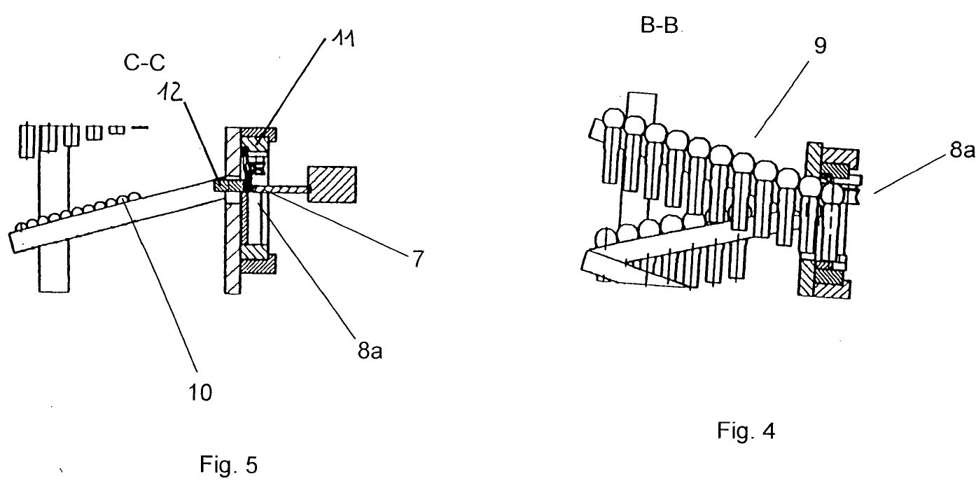

FIG. 4 shows section B-B according to FIG. 3,

FIG. 5 shows section C-C according to FIG. 3, and

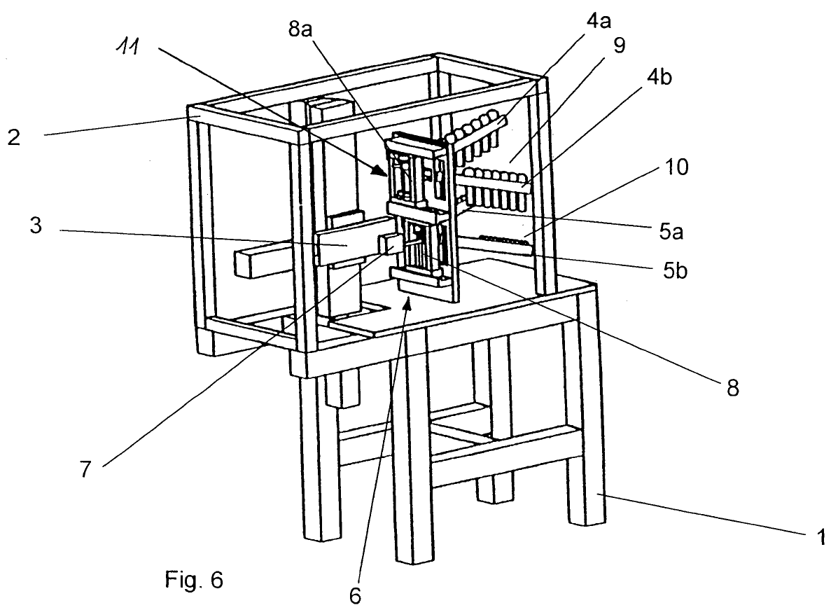

FIG. 6 shows a perspective view of the embodiment according to FIG. 1.

The crack detection unit according to FIG. 1 comprises a base 1, on which a moving unit 3, preferably a biaxial linear moving unit, a first feeding and removal unit 4 and a second feeding and removal unit 5, between which a checking carriage unit 11 each is located, as well as a detection unit 7 (not visible here, see FIG. 6) are accommodated in a frame 2.

FIG. 2 shows the biaxial moving unit 3 comprising a horizontal moving unit 3a and a vertical moving unit 3b in greater detail, wherein a first measuring unit 14 (not shown) of a detection unit 7, which said measuring unit is designed as a sensor, is fastened on the moving unit 3. The detection unit 7 checks the parts to be checked for cracks. The signals sent by the detection unit 7 are measured with the measuring unit 14. In addition to the measuring unit 14 described, a distance measuring unit 15 [sic—Tr.Ed.] (not shown) is provided. This measures the distance between the first measuring unit 15 and the part 9 to be checked and sends the measured data to a control circuit (not shown). This control circuit ensures that the actual distance between the first measuring unit 14 and the part 9 to be checked always corresponds to the preset desired distance. The horizontal moving unit 3a is coupled with the vertical moving unit 3b, as a result of which it is achieved that the detection unit 7 can be moved two-dimensionally. The feeding is achieved via two longitudinal transfer means designed as feeding and removal units 4a, 4b and 5a, 5b, which are coupled with a checking carriage unit 11 (not shown here) each, the feeding being laterally offset in relation to the moving unit. The parts 9, 10 to be checked are conveyed to and from the checking carriage unit via the respective feeding and removal units 4a, 4b, 5a, 5b. The checking carriage unit conveys the parts 9, 10 to be checked from the feeding position—the position at which the transfer from the feeding unit 4a, 5a to the checking carriage unit takes place—to the checking position or checking positions 8a and 8b, and from there farther to the removal position—the position at which the transfer from the checking carriage unit to the removal unit 4b, 5b takes place—the checking positions 8a, 8b always being located between the respective feeding and removal positions. The checking positions 8a and 8b are arranged offset in relation to one another in the vertical direction. The feeding, checking and removal positions are each arranged on a straight line.

FIG. 3 shows more clearly the two checking positions 8a and 8b.

FIG. 4 shows the feeding of the test specimens 9, 10.

FIG. 5 shows a type of test specimen 10 deviating from the type of test specimen 9 shown in FIG. 4 in the checking means. The part 10 to be checked is located in the checking position 8b (see FIG. 3) with the drive unit 12, which is in contact with the part 10 to be checked and which is designed as a friction wheel. The part 10 to be checked is set into rotation for checking. The speed of the parts 9, 10 to be checked is preferably above 1,000 revolutions per minute. Furthermore, the position of the detection unit 7, which is moved during the rotary movement of the test specimen 10 along the outer contour of the test specimen 10, so that it checks the test specimen 10 for cracks via its outer contour by means of a suitable crack detection method, is shown. A suitable crack detection method can be embodied, e.g., by the use of X-rays. The data determined are sent to a data processing unit (not shown).

FIG. 6 shows a summary perspective view of the entire crack detection unit. The control unit 13 responsible for the control of the moving units 3 is not shown. The control is preferably performed by means of CNC programming. The function of the unit can be generally followed on the basis of the view. The different types of test specimens 9, 10 are moved one after another into the respective checking position 8a, 8b via the feeding systems 4a and 5a and via the checking carriage units 11. They are set into rotation there by means of a drive unit 12 (not shown here). The detection unit 7 is moved to the checking position 8a via the moving unit 3, which was preferably programmed correspondingly by means of a CNC control. The measuring unit 14 receives there the signals sent by the detection unit 7, preferably X-rays or eddy currents, and measures these in order to obtain corresponding data on the surface of the outer contour of the parts being checked, and sends these data to a data processing unit (not shown). The tracing of the outer contour is preferably performed via a CNC control (not shown), in which the corresponding outer contour of the test specimen was programmed. In addition, a distance measuring unit is provided, which continuously measures the distance between the detection unit 7 and the part 9 to be checked and transmits the measured data to a control circuit. This control circuit controls the actual distance between the detection unit 7 and the part 9 to be checked corresponding to a preset desired value. Automatic control of the distance between the detection unit 7 and the part 9 to be checked can thus be embodied. After the detection of the measured data of the test specimen, the moving unit 3 moves the detection unit 7 into the second checking position 8b. While the test specimen just checked is being moved away from its checking position 8a and a new test specimen is being fed in and set into rotation, the surface of the test specimen located in the checking position 8b is being measured at the same time. Due to the distance measuring unit 15, it is no longer necessary for the parts to be checked to have a rotationally symmetrical outer contour in the area of measurement.

The embodiment of the present invention is not limited to the above-described preferred exemplary embodiment. A number of variants is rather conceivable, which also make use of the solution described in fundamentally different embodiments.

### LIST OF REFERENCE NUMBERS

1 Base

2 Frame

3 Moving unit

3a Horizontal linear moving unit

3b Vertical linear moving unit

4 First feeding and removal unit

4a First feeding unit

4b First removal unit

5 Second feeding and removal unit

5a Second feeding unit

5b Second feeding unit

6 Checking means

7 Detection unit

8 Checking position

8a Checking position 1

8b Checking position 2

9 Parts to be checked (test specimens of type A)

10 Parts to be checked (test specimens of type B)

11 Checking carriage unit

12 Drive unit

13 Control unit

14 Measuring unit

15 Distance measuring unit

1. Crack detection device with at least one said detection unit (7) for checking said parts (9, 10) for cracks with the use of a suitable crack detection method, characterized in that the said detection unit (7) is movable by means of a said moving unit (3) between at least two said checking positions (8a, 8b), wherein a said part (9, 10) to be checked each can be fed to each of the said checking positions (8a, 8b).

2. Crack detection device in accordance with claim 1, characterized in that the crack detection device has a said feeding and removal unit (4, 5), which feeds the said parts (9, 10) to be checked into the said checking positions (8a, 8b) and removes the said parts (9, 10) to be checked from the said checking positions (8a, 8b).

3. Crack detection device in accordance with claim 2, characterized in that the said feeding and removal unit (4, 5) comprises at least two said, linearly movable checking carriage units (11), which are arranged vertically one on top of another and by which the said parts (9, 10) to be checked can be moved between different positions.

4. Crack detection device in accordance with claim 3, characterized in that the parts to be checked are movable by the said linearly movable checking carriage units (11) between a said feeding position, one of the said checking positions (8a, 8b) and a said removal position.

5. Crack detection device in accordance with claim 4, characterized in that each of the said checking positions (8a, 8b) is arranged between the respective feeding position and the respective removal position located on the same line with these.

6. Crack detection device in accordance with one of the claims 3 through 5, characterized in that at least one said linear transfer system, which is coupled with the said respective checking carriage unit (11), is associated per checking position with the said feeding and removal unit (4, 5).

7. Crack detection device in accordance with claim 6, characterized in that to convey said different parts (9, 10), the said linear transfer system associated with the said first checking position is different from the said linear transfer system associated with the said second checking position.

8. Crack detection device in accordance with one of the claims 3 through 7, characterized in that the said parts (9, 10) to be checked are mounted in the said checking positions (8a, 8b) rotatably in the said checking carriage unit (11).

9. Crack detection device in accordance with one of the above claims, characterized in that in each said checking position (8a, 8b), the said crack detection device has a said drive unit (12) for rotating the said parts (9, 10) arranged in the said checking stations (8a, 8b).

10. Crack detection device in accordance with claim 9, characterized in that each of the said drive units (12) is designed as a said friction wheel, which is driven by an electric motor and is contact with the said respective part (9, 10) to be checked in the respective checking position (8).

11. Crack detection device in accordance with claim 9 or 10, characterized in that the said parts (9, 10) to be checked are rotatable by the said drive unit (12) at a speed of at least 1,000 revolutions per minute.

12. Crack detection device in accordance with one of the above claims, characterized in that the said moving unit (3) is operated by an electric motor, hydraulically or pneumatically and is controlled by a said control unit (13).

13. Crack detection device in accordance with claim 12, characterized in that the said control unit (13) has a said programmable contour tracing control.

14. Crack detection device in accordance with one of the above claims, characterized in that the said detection unit (7) comprises at least one measuring sensor.

15. Crack detection device in accordance with one of the above claims, characterized in that the said detection unit (7) is arranged on the said moving unit (3).

16. Crack detection device in accordance with one of the above claims, characterized in that the said moving unit (3) is a biaxial linear moving unit with a said horizontal axis (3a) and with a said vertical axis (3b).

17. Crack detection device in accordance with one of the above claims, characterized in that the said detection unit (7) additionally has at least one said distance measuring unit, by which the distance between the said detection unit (7) and a said part (9, 10) to be checked, which is fed into one of the said checking positions, can be determined.

18. Crack detection device in accordance with one of the above claims, characterized in that the said parts (9, 10), especially ball pivots, have a rotationally symmetrical outer contour in the area of measurement.

19. Crack detection device in accordance with one of the above claims, characterized in that the suitable crack detection method is an eddy current method or an optical crack detection method.

20. Method for checking said parts (9, 10) for cracks with the use of a suitable crack detection method, wherein a said first part (9) of the said parts (9, 10) to be checked is fed into a said first checking position (8a) and is checked for cracks with the use of at least one said detection unit (7) arranged in the said first checking position (8a), characterized in that
a said second part (10) of the said parts (9, 10) to be checked is fed into a said second checking position (8b),
the said detection unit (7) is moved to the said second checking position after the checking of the said first part (9), and
the said second part (10) is checked for cracks with the use of the said detection unit (7).

21. Method in accordance with claim 20, characterized in that the suitable crack detection method is an eddy current method or an optical crack detection method.
